(19) United States
(12) Patent Application Publication
(10) Pub. No.: US 2025/0233151 A1
(43) Pub. Date: Jul. 17, 2025

(54) COMPOSITE MATERIALS FORMING SOLID INTERPHASE LAYERS, BATTERIES CONTAINING THE SAME, AND METHODS OF MAKING THE SAME

(71) Applicant: BOARD OF REGENTS, THE UNIVERSITY OF TEXAS SYSTEM, Austin, TX (US)

(72) Inventors: Gyeong S. HWANG, Austin, TX (US); Swastik BASU, Austin, TX (US); Jiwon YU, Austin, TX (US)

(21) Appl. No.: 18/855,986

(22) PCT Filed: Apr. 10, 2023
(86) PCT No.: PCT/US2023/018023

§ 371 Date: Oct. 10, 2024

Related U.S. Application Data
(60) Provisional application No. 63/329,700, filed on Apr. 11, 2022.

(51) Int. Cl. H01M 4/62; H01M 4/38; H01M 10/052

(52) U.S. Cl. CPC H01M 4/62; H01M 4/382; H01M 10/052; H01M 2300/0071; H01M 2300/0082

(57) ABSTRACT

An electrode material comprising: an anode metal material having an electrochemically active surface; and comprising a) a carbonaceous polymeric material halogenated with a first halogen and a first amorphous halide salt incorporated in a matrix of the carbonaceous polymeric material; or b) an inorganic material halogenated with a third halogen; and a second amorphous halide salt incorporated in a matrix of the inorganic material; and wherein the composite material is a layer disposed on the electrochemically active surface of the anode metal material.

### CROSS-REFERENCE TO RELATED APPLICATIONS

This application claims the benefit of U.S. Provisional Application No. 63/329,700 filed Apr. 11, 2022, the content of which is incorporated herein by reference in its entirety.

### TECHNICAL FIELD

This application relates generally to composite materials forming electrolyte interphase layers and batteries comprising the same.

### BACKGROUND

Insufficient electrochemical stability of the electrolyte may result in its reductive decomposition on the negative electrode surface, leading to the formation and growth of an interfacial layer which is called the Solid Electrolyte Interphase (SEI). Stable and insulating SEI can perform beneficial functions as a protective layer, given that it can block electron transport from the anode to the electrolyte, prevent solvent molecules from reaching the anode, and at the same time, allow Li-ion (Li⁺) transport. While the SEI is critical to the operability of various batteries, and especially of lithium-ion batteries (LIBs), the conditions under which it is formed significantly affect battery performance, namely cell impedance, irreversible capacity loss, and thermal stability, and rate of capacity fade at higher charge rates. In particular, the growth of dendrites during cycling is known to result in continuous electrolyte degradation through the destruction of the SEI. In lithium batteries, the formation of so-called “dead lithium” is also observed, which can result in short-circuiting of the battery if the dendrite reaches the positive electrode. Especially for next-generation electric vehicles (EVs), all-solid-state lithium-metal batteries (ASSLMBs) have garnered considerable attention due to their advantages in terms of energy storage capacity and safety over LIBs. However, the large interfacial impedance originating from poor physical contact and/or parasitic reactions at the Li/SSE interface hinders the development of ASSLMs. The interfacial stability and compatibility greatly affect the electrochemical performance of not only ASSLMs but also LIBs. Therefore, it is critical to devise strategies for the formation of an effective interfacial layer at the electrode/electrolyte interface that can suppress electrolyte decomposition and Li dendrite propagation by blocking electron transport while allowing lithium ions to readily travel through it during cycling.

Thus, new approaches to provide for stable solid electrolyte interface (SEI) that address these needs are needed. Electrochemical cells utilizing these new stable solid electrolyte interface (SEI) layers are also needed. These needs and other needs are at least partially satisfied by the present disclosure.

### SUMMARY

The present disclosure is directed to an electrode material comprising: an anode metal material having an electrochemically active surface; and a composite material comprising aa) a carbonaceous polymeric material halogenated with a first halogen and comprising: at least one atom selected from nitrogen, oxygen, phosphorous, sulfur, boron, a second halogen that is different from the first halogen, or any combination thereof within a polymeric chain; and a first amorphous halide salt incorporated in a matrix of the carbonaceous polymeric material, wherein the first amorphous halide salt comprises a cation of one or more metals, wherein the one or more metals comprise the anode metal material and wherein an anion of the first amorphous halide salt comprises the first halogen or the second halogen, or a mixture thereof; or b) an inorganic material halogenated with a third halogen and comprising: one or more elements of Group III and/or Group V, a fourth halogen, or a combination thereof, wherein the fourth halogen is different from the third halogen; and a second amorphous halide salt incorporated in a matrix of the inorganic material, wherein the second amorphous halide salt comprises a cation of one or more metals, wherein the one or more metals comprise the anode metal material; and wherein an anion of the second amorphous halide salt comprises the third halogen, the fourth halogen, or a mixture thereof; and wherein the composite material is a layer disposed on the electrochemically active surface of the anode metal material.

Also disclosed are aspects where when the composite material comprises the carbonaceous polymeric material halogenated with the first halogen, the first halogen and/or second halogen, if present, comprises an F, Cl, Br, and/or I. In still further aspects, the carbonaceous polymeric material halogenated with the first halogen comprises one or more of nitrogen-functionalized trifluoro-ethyl phosphate, nitrogen-functionalized difluoro-ethyl phosphate, perfluoro-2-methyl-3-pentanone, perfluorocarbon iodide, or any combination thereof.

In yet further aspects, when the composite material comprises the inorganic material halogenated with the third halogen, the third halogen and/or fourth halogen, if present, comprises an F, Cl, Br, and/or I. In still further aspects, the inorganic material halogenated with the third halogen comprises fluorinated boron nitride, fluorinated boron phosphide, or any combination thereof.

In yet still further aspects, the composite material exhibits an ion conductivity ranging from about 1 mS/cm to about 20 mS/cm at room temperature.

Also disclosed herein is a battery comprising any one of the disclosed herein electrode materials. In yet further aspects, the battery can also comprise an electrolyte. In yet further aspects, the battery disclosed herein can further comprise a cathode material.

In still further aspects, disclosed herein is a thin film comprising a composite material comprising: a carbonaceous polymeric material halogenated with a first halogen and comprising: at least one atom selected from nitrogen, oxygen, phosphorous, sulfur, boron, a second halogen that is different from the first halogen, or any combination thereof within a polymeric chain; and a first amorphous halide salt incorporated in a matrix of the carbonaceous polymeric material, wherein the first amorphous halide salt comprises a metal cation and an anion of the first and/or second halogen.

While in still further aspects, disclosed herein is a thin film comprising a composite mater comprising: an inorganic material halogenated with a third halogen and comprising: one or more elements of Group III and/or Group V, a fourth halogen, or a combination thereof, wherein the fourth halogen is different from the third halogen; and a second amorphous halide salt incorporated in a matrix of the inorganic material, wherein the second halide salt comprises a metal cation and an anion of the first and/or second halogen.

Also disclosed herein is a solid ion-conducting composite comprising: a) a thin film solid electrolyte comprising one or more of sulfide compounds, garnet structure oxides, LISICON-type solids, NASICON-type phosphate glass ceramics, perovskite-type and anti-perovskite type compounds, nitrides, oxynitrides, argyrodite-type, polymer-based electrolytes, or any combination thereof, and b) a protective layer comprising any of the disclosed herein thin films disposed on the thin film solid electrolyte surface

In still further aspects, disclosed herein is a method of making any of the disclosed herein electrode materials, wherein the methods comprise ex-situ formation of the composite material or in-situ formation of the composite material by a chemical reaction with an ex-situ or in-situ deposited precursor layer, chemical combination of additives and/or salts added to the electrolyte, or any combination thereof.

Also disclosed are methods of making any of the disclosed herein batteries comprising a) providing any of the disclosed herein electrode materials, b) providing an electrolyte, and c) providing a cathode material.

Additional advantages will be set forth in part in the description which follows, and in part will be obvious from the description or can be learned by practice of the aspects described below. The advantages described below will be realized and attained by means of the chemical compositions, methods, and combinations thereof, particularly pointed out in the appended claims. It is to be understood that both the foregoing general description and the following detailed description are exemplary and explanatory only and is not restrictive of the invention, as claimed.

### BRIEF DESCRIPTION OF DRAWINGS

FIG. 1 depicts a schematic of an exemplary precursor coating on various interfaces of LMBs.

FIGS. 2A-2B depict simulation snapshots showing the lithiation of a carbon fluoride precursor, LiF formation (FIG. 2A) and subsequent phase transformation within LiF (FIG. 2B). Light balls represent Li, and dark balls represent F.

FIGS. 3A-3C depict simulation snapshots showing the formation of amorphous LiF in a matrix of exemplary coatings having N-functionalized fluorinated carbon (FIG. 3A) and oxygen-functionalized fluorinated carbon (FIG. 3B); and the corresponding formation energy profiles for lithiation reactions (FIG. 3C). Light balls represent Li, dark balls represent F.

FIG. 4 depicts simulation snapshots showing the lithiation of a chosen precursor composition (N-functionalized trifluoroethyl phosphate, denoted as TFEPN). Light balls represent Li, and dark balls represent F.

FIGS. 5A-5C depict key properties (transport, mechanical, electronic) of lithiation products formed from TFEPN.

FIG. 6 depicts the formation of an amorphous LiF matrix within the boron nitride cage upon defluorination in one aspect. Light balls represent Li, and dark balls represent F.

FIG. 7A-7C depicts the formation of the lithiation products at SSE grain boundaries (FIG. 7A-7B), as well as their effect on electronic insulation (FIG. 7C).

The accompanying figures, which are incorporated in and constitute a part of this specification, illustrate several aspects described below.

### DETAILED DESCRIPTION

The present invention can be understood more readily by reference to the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

### Definitions

As used herein, the terms “optional” or “optionally” mean that the subsequently described event or circumstance can or cannot occur and that the description includes instances where said event or circumstance occurs and instances where it does not.

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

As used in the description and the appended claims, the singular forms “a,” “an,” and “the” include plural referents unless the context clearly dictates otherwise. Thus, for example, a reference to “a salt” includes two or more such salts, reference to “a battery” includes two or more such batteries and the like.

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims which follow, reference will be made to a number of terms that shall be defined herein.

For the terms “for example” and “such as,” and grammatical equivalences thereof, the phrase “and without limitation” is understood to follow unless explicitly stated otherwise. It is further understood that these phrases are used for explanatory purposes only. It is further understood that the term “exemplary,” as used herein, means “an example of” and is not intended to convey an indication of a preferred or ideal aspect.

The expressions “ambient temperature” and “room temperature” as used herein are understood in the art and refer generally to a temperature from about 20° C. to about 35° C.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values, inclusive of the recited values, may be used. Further, ranges can be expressed herein as from “about” one particular value and/or to “about” another particular value. When such a range is expressed, another aspect includes from the one particular value and/or to the other particular value.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, a description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

In still further aspects, when the specific values are disclosed between two end values, it is understood that these end values can also be included.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight, components Y, X, and Y are present at a weight ratio of 2:5 and are present in such a ratio regardless of whether additional components are contained in the mixture.

A weight percent (wt. %) of a component, unless specifically stated to the contrary, is based on the total weight of the formulation or composition in which the component is included.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”).

As used herein, the term “and/or” includes any and all combinations of one or more of the associated listed items.

It will be understood that although the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

As used herein, the term “substantially” means that the subsequently described event or circumstance completely occurs or that the subsequently described event or circumstance generally, typically, or approximately occurs.

Still further, the term “substantially” can, in some aspects, refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition.

While aspects of the present invention can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to the arrangement of steps or operational flow, plain meaning derived from grammatical organization or punctuation, or the number or type of aspects described in the specification.

The present invention may be understood more readily by reference to the following detailed description of various aspects of the invention and the examples included therein and to the Figures and their previous and following description.

As disclosed above, the current disclosure, in a first aspect, is directed to an electrode material comprising: an anode metal material having an electrochemically active surface; and a composite material comprising: a carbonaceous polymeric material halogenated with a first halogen and comprising: at least one atom selected from nitrogen, oxygen, phosphorous, sulfur, boron, a second halogen that is different from the first halogen, or any combination thereof within a polymeric chain, and a first amorphous halide salt incorporated in a matrix of the carbonaceous polymeric material, wherein the first amorphous halide salt comprises a cation of one or more metals, wherein the one or more metals comprise the anode metal material and wherein an anion of the first amorphous halide salt comprises the first halogen or the second halogen, or a mixture thereof.

Yet, in another alternative, the non-limiting second aspect, the electrode material can comprise an anode metal material having an electrochemically active surface; and a composite material comprising: an inorganic material halogenated with a third halogen and comprising one or more elements of Group III and/or Group V, a fourth halogen, or a combination thereof, wherein the fourth halogen is different from the third halogen; a second amorphous halide salt incorporated in a matrix of the inorganic material, wherein the second amorphous halide salt comprises a cation of one or more metals, wherein the one or more metals comprise the anode metal material; and wherein an anion of the second amorphous halide salt comprises the third halogen, the fourth halogen, or a mixture thereof; and wherein the composite material is a layer disposed on the electrochemically active surface of the anode metal material.

It is understood that the present disclosure can comprise the electrode material as described in either or both of the first and/or second aspects.

In certain aspects, the anode metal material can comprise an alkali metal. Yet, in other aspects, the anode metal material can comprise an alkaline-earth metal material. In yet still further aspects, the anode metal material can comprise alloys of the alkali metal, alloys of the alkaline-earth metal material, or alloys of the alkali and the alkaline-earth metal materials. In still further aspects, any electrochemically active metals can be contemplated.

In still further aspects, the anode metal material can comprise lithium, sodium, potassium, magnesium, aluminum, zinc, or alloys thereof. In still further aspects, the anode material can also comprise zinc. In still further aspects, the anode material is lithium. While in other aspects, the anode material is sodium. While in still further aspects, the anode material is potassium. Yet, in still further aspects, the anode material is magnesium. While in still further aspects, the anode material is aluminum. It is also understood that the anode material can be an alloy or a combination of alloys of any of the disclosed above metals.

In still further aspects when the composite material comprises the carbonaceous polymeric material halogenated with the first halogen, the first halogen and/or second halogen, if present, can comprise an F, Cl, Br, and/or I. In such exemplary and unlimiting aspects, the first halogen can be F. In yet other aspects, the first halogen can be Cl. In still further aspects, the first halogen can be Br. In still further aspects, the first halogen can be I. Yet, in still further aspects, the second halogen, if present, can be I. While in other aspects, the second halogen, if present, can be F. Yet in still further aspects, the second halogen, if present, can be Br. Yet, in still further aspects, the second halogen, if present, can be Cl.

In still further aspects, in the carbonaceous polymeric material a ratio of the first halogen to carbon is between 0 and 2, including exemplary values of 0.1, 0.5, 0.75, 1, 1.1, 1.25, 1.5, and 1.75. It is understood that any value between any two foregoing values can be contemplated.

In still further aspects, when the carbonaceous polymer material is present, such a material halogenated with the first halogen can comprise one or more of nitrogen-functionalized trifluoro-ethyl phosphate, nitrogen-functionalized difluoro-ethyl phosphate, perfluoro-2-methyl-3-pentanone, perfluorocarbon iodide, or any combination thereof. It is understood, however, that these compounds are exemplary and non-limiting, and any other carbonaceous halogenated compounds can be utilized.

Yet, in still further aspects, when the composite material comprises the inorganic material halogenated with the third halogen, the third halogen and/or fourth halogen, if present, comprises an F, Cl, Br, and/or I. In such exemplary and unlimiting aspects, the third halogen can be F. Yet, in other aspects, the third halogen can be Cl. Yet, in other aspects, the third halogen can be Br. Yet, in other aspects, the third halogen can be I.

In still further aspects, the inorganic material halogenated with the third halogen can comprise fluorinated boron nitride, fluorinated boron phosphide, or any combination thereof. It is understood that other halogenated inorganic compounds (for example, fluorinated inorganic compounds) can be chosen according to the aspects of the present disclosure.

It is understood, and as disclosed above, that the first and/or the second halide salts can comprise a chloride salt, a fluoride salt, a bromide salt, an iodide salt of the anode metal material, or a combination thereof. It is understood that if the combination of halide salts is present, each of the present halide salt can be in any amount relative to each other. In still further aspects, the first and/or second halide salt is amorphous lithium fluoride. Yet, in certain aspects, the first and/or second halide salt can be amorphous sodium fluoride, or amorphous potassium fluoride, or amorphous magnesium fluoride, or amorphous aluminum fluoride, or a combination thereof. Similarly, it can be lithium chloride or sodium chloride, and so on.

In still further aspects, the one or more metals further comprise an alkali or an alkaline-earth metal material that is different from the anode metal material. Any known in the art alkali or alkaline-earth metal materials can be utilized as long as they are different from the anode metal material.

In some aspects, the anode metal material is lithium. In yet other aspects, the first and/or the second halide salt is amorphous lithium fluoride.

In some aspects, the composite disclosed herein is capable of forming an effective interfacial layer at the electrode/electrolyte interface that can minimize electrolyte decomposition and metal dendrite propagation by blocking electron transport while allowing metal ions to readily travel through it during cycling. In such aspects, and as disclosed above, the effective interfacial material is amorphous LiF. In such exemplary and unlimiting aspects, the disclosed composited are highly interactive with lithium anode material and, therefore, can prevent Li-accumulation and dendrite growth while at the same time promoting an extremely diffusive regime in the form of amorphous LiF with sufficient electron-blocking character.

In the aspects disclosed herein, whether the composite material is the carbonaceous material described in the first aspect or the inorganic material described in the second aspect, such a composite material can be present as a continuous thin film. However, in certain exemplary and unlimiting aspects, the composite material can be present as a discontinuous film if desired. It is understood that, if desired, a specific pattern of the composite material can also be obtained.

In still further aspects, the composite material exhibits an ion conductivity ranging from about 1 mS/cm to about 20 mS/cm at room temperature, including exemplary values of about 2 mS/cm, about 5 mS/cm, about 7 mS/cm, about 10 mS/cm, about 12 mS/cm, about 15 mS/cm, and about 17 mS/cm. In yet further aspects, the composite material can exhibit an ion conductivity ranging from about 8 mS/cm to about 20 mS/cm, including exemplary values of about 9 mS/cm, about 10 mS/cm, about 11 mS/cm, about 12 mS/cm, about 14 mS/cm, about 15 mS/cm, about 16 mS/cm, about 17 mS/cm, about 18 mS/cm, and about 19 mS/cm at room temperature.

In certain aspects, a metal anode cation self-diffusion coefficient in the disclosed herein composite material is from about 5×10⁻¹⁰ to about 1×10⁻⁷ cm²/s, including exemplary values of about 7.5×10⁻¹⁰ cm²/s, about 1×10⁻⁹ cm²/s, about 2.5×10⁻⁹ cm²/s, about 5×10⁻⁹ cm²/s, about 7.5×10⁻⁹ cm²/s, about 1×10⁻⁸ cm²/s, about 2.5×10⁻⁸ cm²/s, about 5×10⁻⁸ cm²/s, and about 7.5×10⁻⁸ cm²/s.

In still further aspects, the disclosed herein composite material is a substantially electrical insulator. In certain aspects, the composite material exhibits an electronic conductivity of less than about 10⁻⁹ S cm⁻¹, less than about 10⁻¹⁰ S cm⁻¹, or even less than about 10⁻¹¹ S cm⁻¹. Yet, in other aspects, the composite material exhibits electrical resistivity greater than about 10⁷ Ω·cm, greater than about 10⁸ Ω·cm, greater than about 10⁸ Ω·cm, greater than about 10¹⁰ Ω·cm, or even greater than about 10¹¹ Ω·cm.

In still further aspects, the composite material disclosed herein is substantially ductile. In still further aspects, the composite material is ductile. In still further aspects, the composite material exhibits a substantially ductile behavior under stress. Without wishing to be bound by any theory, it is understood that such ductile behavior is due to the presence of the first and/or second amorphous halide salts in the composite material. It is further understood that if the composite material comprises only a crystalline phase, ductile behavior would not be observed.

In some aspects, the composite material can have desired mechanical properties that would allow for prolonging its operational lifetime. In some aspects, the composite material exhibits a bulk modulus from about 35 GPa to about 60 GPa, including exemplary values of about 36 GPa, about 37 GPa, about 38 GPa, about 39 GPa, about 40 GPa, about 41 GPa, about 42 GPa, about 43 GPa, about 44 GPa, about 45 GPa, about 46 GPa, about 47 GPa, about 48 GPa, about 49 GPa, about 50 GPa, about 51 GPa, about 52 GPa, about 53 GPa, about 54 GPa, about 55 GPa, about 56 GPa, about 57 GPa, about 58 GPa, and about 59 GPa.

In still further aspects, the composite material exhibits a shear modulus from about 15 GPa to about 30 GPa, including exemplary values of about 16 GPa, about 17 GPa, about 18 GPa, about 19 GPa, about 20 GPa, about 21 GPa, about 22 GPa, about 23 GPa, about 24 GPa, about 25 GPa, about 26 GPa, about 27 GPa, about 28 GPa, and about 29 GPa.

In still further aspects, the composite material exhibits an elastic modulus from about 45 GPa to about 70 GPa, including exemplary values of about 46 GPa, about 47 GPa, about 48 GPa, about 49 GPa, about 50 GPa, about 51 GPa, about 52 GPa, about 53 GPa, about 54 GPa, about 55 GPa, about 56 GPa, about 57 GPa, about 58 GPa, about 59 GPa, about 60 GPa, about 61 GPa, about 62 GPa, about 63 GPa, about 64 GPa, about 65 GPa, about 66 GPa, about 67 GPa, about 68 GPa, and about 69 GPa.

In still further aspects, the electrochemically active surface comprises an anode metal material/electrolyte interface, one or more grain boundaries in the anode metal material, one or more cracks in the anode metal material, or any combination thereof. It is understood that the disclosed herein composite material can be disposed on any of the above mentioned electrochemically active surfaces of the anode metal material individually or on all existing surfaces. In yet still further aspects, the composite material can form a solid electrolyte interface (SEI) layer.

In still further aspects, the composite material that is disposed on the electrochemically active surface of the anode metal material can be amorphous-phase rich. In certain aspects, and as disclosed above, the composite material can comprise the halogenated carbonaceous polymeric material comprising the first amorphous halide salt. In such aspects, such a composite material has an amorphous-rich phase. For example, at least about 5% of the composite material comprises the first amorphous halide salt, at least about 10% of the composite material comprises the first amorphous halide salt, at least about 15% of the composite material comprises the first amorphous halide salt, at least about 20% of the composite material comprises the first amorphous halide salt, at least about 25% of the composite material comprises the first amorphous halide salt, at least about 30% of the composite material comprises the first amorphous halide salt, at least about 35% of the composite material comprises the first amorphous halide salt, at least about 40% of the composite material comprises the first amorphous halide salt, at least about 45% of the composite material comprises the first amorphous halide salt, at least about 50% of the composite material comprises the first amorphous halide salt, at least about 55% of the composite material comprises the first amorphous halide salt, at least about 60% of the composite material comprises the first amorphous halide salt, at least about 65% of the composite material comprises the first amorphous halide salt, at least about 70% of the composite material comprises the first amorphous halide salt, or at least about 75% of the composite material comprises the first amorphous halide salt.

In other aspects, and as disclosed above, the composite material can comprise the halogenated inorganic material comprising the second amorphous halide salt. In such aspects, such a composite material also has an amorphous-rich phase. For example, at least about 5% of the composite material comprises the second amorphous halide salt, at least about 10% of the composite material comprises the second amorphous halide salt, at least about 15% of the composite material comprises the second amorphous halide salt, at least about 20% of the composite material comprises the second amorphous halide salt, at least about 25% of the composite material comprises the second amorphous halide salt, at least about 30% of the composite material comprises the second amorphous halide salt, at least about 35% of the composite material comprises the second amorphous halide salt, at least about 40% of the composite material comprises the second amorphous halide salt, at least about 45% of the composite material comprises the second amorphous halide salt, at least about 50% of the composite material comprises the second amorphous halide salt, at least about 55% of the composite material comprises the second amorphous halide salt, at least about 60% of the composite material comprises the second amorphous halide salt, at least about 65% of the composite material comprises the second amorphous halide salt, at least about 70% of the composite material comprises the second amorphous halide salt, or at least about 75% of the composite material comprises the second amorphous halide salt.

However, in some aspects, these composite materials can also comprise a combination of crystalline and amorphous phases of the first halide salt or the second halide salt, depending on the type of the composite material.

In still further aspects, the composite material is configured to substantially wet the electrochemically active surface of the anode metal material.

In still further aspects, the composite material can have a volumetric strain greater than 0% and less than 100%, including exemplary values of about 1%, about 5%, about 10%, about 15%, about 20%, about 25%, about 30%, about 35%, about 40%, about 45%, about 50%, about 55%, about 60%, about 65%, about 70%, about 75%, about 80%, about 85%, about 80%, and about 95%. In yet still further aspects, the amorphous halide salt can have a volumetric strain between about 10% and about 50%, including exemplary values of about 12%, about 15%, about 17%, about 20%, about 22%, about 25%, about 28%, about 30%, about 32%, about 35%, about 38%, about 40%, about 42%, about 45%, and about 48%.

In yet other aspects, the composite material can have a volumetric compression. In such aspects, the composite material can be compressed to up to about 10% of an initial thickness, up to about 20% of an initial thickness, up to about 30% of an initial thickness, up to about 40% of an initial thickness, up to about 50% of an initial thickness, up to about 60% of an initial thickness, up to about 70% of an initial thickness, up to about 80% of an initial thickness, up to about 90% of an initial thickness, up to about 95% of an initial thickness. In still further aspects, the composite material can be compressed to about 1%, about 2%, about 3%, about 5%, about 6%, about 7%, about 8%, about 9%, about 10%, about 11%, about 12%, about 13%, about 14%, about 15%, about 16%, about 17%, about 18%, about 19%, about 20%, about 23%, about 25%, about 27%, about 30%, about 32%, about 35%, about 37%, about 40%, about 43%, about 45%, about 47%, about 50% of an initial thickness. In yet other aspects, the composite material can be compressed to about 50%, about 53%, about 55%, about 57%, about 60%, about 63%, about 65%, about 70%, about 73%, about 75%, about 77%, about 80%, about 83%, about 85%, about 87%, about 90%, about 93%, about 95%, or about 99% of an initial thickness. It is understood that compression can be achieved by any known in the art methods. For example, by applying an external force.

In still further aspects, the composite material the current disclosure can have a thickness between about 1 nm to about 500 nm, including exemplary values of about 5 nm, about 10 nm, about 20 nm, about 30 nm, about 40 nm, about 50 nm, about 60 nm, about 70 nm, about 80 nm, about 90 nm, about 100 nm, about 150 nm, about 200 nm, about 250 nm, about 300 nm, about 350 nm, about 400 nm, and about 450 nm.

In still further aspects, the composite material is configured to substantially prevent the formation of dendrites on any of the disclosed electrochemically active surfaces of the anode metal material. While in still further aspects, the composite material is configured to substantially suppress the decomposition of an electrolyte when it is in contact with the electrolyte.

In still further aspects, the composite material is substantially stable at room temperature.

While in other aspects, when the disclosed electrode materials are used in a battery configuration or any other electrochemical configuration, the composite material is also stable under the battery operating conditions or under other operating conditions of the electrochemical configuration.

Still further disclosed herein is a battery. In such aspects, the battery can comprise any of the disclosed above electrode materials. In still further aspects, the battery comprises an electrolyte. As discussed above, the electrolyte can be solid or liquid, depending on the desired application.

In still further aspects, when the electrolyte is solid, the composite material is configured to substantially wet a surface of a such solid electrolyte.

In still further aspects, the solid electrolyte can comprise sulfide compounds, garnet structure oxides, LISICON-type solids, NASICON-type phosphate glass ceramics, perovskite-type and anti-perovskite type compounds, nitrides, oxynitrides, argyrodite-type, or polymer-based electrolytes, or any combination thereof. If the electrolyte is polymer-based electrolytes, such electrolytes can further comprise an alkali metal, an alkaline-earth metal salt, or a combination thereof.

In still further aspects, the alkali metal salt or alkaline-earth metal salt can comprise any of the alkali metal salt that is suitable for the desired application. It is also understood that the alkali metal salt or alkaline-earth metal salt composition can be defined by the final use. For example, if the solid electrolyte is designed for use in a lithium electrochemical cell, the alkali metal salt can comprise Li cations. However, it is also understood that if the solid electrolyte is designed for use in sodium or potassium electrochemical cells, the alkali metal salt can comprise Na or K cations and the like.

In still further aspects, the alkali metal salt comprises one or more of bis(trifluoromethane)sulfonimide lithium salt (LiTFSl), lithium perchlorate (LiClO₄), lithium tetrafluoroborate (LiBF₄), lithium hexafluorophosphate (LiPF₆), lithium hexafluroarsenate (LiAsF₆), lithium bis(fluorosulfonyl)imide (LiFSl), lithium aluminum tetrachloride (LiAlCl₄), lithium boron tetrachloride (LiBCl₄), lithium iodide (Lil), lithium chlorate (LiClO₃), LiBrO₃, LilO₃, or a combination thereof.

In still further aspects, the polymer can comprise poly(ethylene oxide) (PEO) polymer, polyethylene glycol (PEG), polyvinylidene fluoride (PVDF), poly(vinyl alcohol) (PVA), poly(vinyl chloride) (PVC), polyacrylonitrile (PAN), poly(methyl methacrylate) (PMMA), poly(vinylidene fluoride-co-hexafluoropropylene) (PVDF-HFP), or any combination thereof. In still further aspects, the polymer can comprise a mixture of the polymers, for example, and without limitations, a cross-linked polymer blend comprising PEO or PEO-PVDF may be selected.

In still further aspects, the solid electrolyte can further comprise a lithium germanium phosphorous sulfide electrolyte, a lithium phosphorus oxynitride electrolyte, a lithium phosphorous sulfide electrolyte, lithium lanthanum zirconium oxide, lithium lanthanum titanium oxide, lithium aluminum germanium phosphate, lithium nitride, or any combination thereof.

In some aspects, the electrolyte is a liquid electrolyte. In such aspects, the electrolyte comprises a salt of a metal cation and a non-aqueous organic solvent. Again, it is understood that the metal cation can be chosen depending on the desired application and can be the same or different from a metal cation present in the halide salt and/or metal anode material. In some aspects, the metal cation can comprise lithium, sodium, potassium, magnesium, aluminum, or a combination thereof.

In still further aspects, any of the known in the art non-aqueous solvents that are traditionally used in the field of batteries and electrochemical devices can be utilized. In some aspects, the non-aqueous organic solvent can comprise ethylene carbonate, dimethyl carbonate, diethyl carbonate, propylene carbonate, dimethoxyethane, ethyl methyl carbonate, N-methyl acetamide, acetonitrile, symmetric sulfone, sulfolane, polyethylene glycol, 1,3-dioxolane, glymes, siloxane, ethylene oxide grafted sulfolane, or a combination thereof.

In still further aspects, the batteries disclosed herein are configured to operate in a temperature range from about 20° C. up to about 60° C., including exemplary values of about 25° C., about 30° C., about 35° C., about 40° C., about 45° C., about 50° C., and about 55° C.

The battery of the present disclosure can further comprise a cathode. It is understood that any known in the art cathode materials that can be useful for the desired purpose can be utilized. In some aspects, the cathode can be a metal cathode or composite cathode. If the metal cathode is used, such an electrochemical cell can be a symmetrical electrochemical cell. In such an exemplary aspect, when the electrochemical cell is symmetrical, both anode and cathode comprise the same material, for example, and without limitation, it can comprise Li. In other words, there are some exemplary aspects where the anode material of the electrochemical cell is Li, and the cathode material used in the same cell is also Li.

In still further aspects, the cathode material can be a composite material. In such aspects, if the electrochemical cell is a lithium electrochemical cell, any known in the art cathode materials that are useful in the Li cell can be utilized. If the electrochemical cell is K or Na cell, any known in the art cathode materials that are useful in Na or K cells can be utilized.

In some aspects, the cathode can also comprise copper, carbon, graphite, sodium, potassium, lithium, magnesium, calcium, aluminum, layered oxides, vanadium-based cathode, sulfur-based cathode, manganese-based cathode, rocksalt cathode, disordered rocksalt cathode, lithium-rich cathode, high voltage ceramic, low voltage ceramic, NMC (nickel-manganese-cobalt oxide) cathode, NCA (nickel-cobalt-aluminum oxide) cathode, LCO (lithium-cobalt oxide) cathode, LFP (lithium iron phosphate) cathode, fluoride-based cathode, sulfur selenium cathode, sulfur selenium tellurium cathode, spinels, olivines, or any combination thereof.

Yet, in still further aspects, the cathode comprises a composite material comprising λ-MnO₂, LiMn₂O₄ spinel, olivine LiFePO₄, FePO₄, layered LiCoO₂ (LCO), LiNi_{y}Mn_{y}Co_{1-2y}O₂ (NMC), LiNiMnO₂, or any combination thereof.

In yet still further aspects, the cathode can comprise a LiFePO₄ composite cathode, a LiNi_{0.8}Co_{0.15}Al_{0.05}O₂, a LiNi_{1/3}Mn_{1/3}Co_{1/3}O₂, a LiNi_{0.4}Mn_{0.3}Co_{0.3}O₂, a LiNi_{0.5}Mn_{0.3}Co_{0.2}O₂, a LiNi_{0.6}Mn_{0.2}Co_{0.2}O₂, a LiNi_{0.8}Mn_{0.1}Co_{0.1}O₂ composite cathode. In yet still further aspects, the cathode material can also comprise a poly(ethylene oxide), cellulose, carboxymethylcellulose (CMC), a polytetrafluoroethylene (PTFE), styrene-butadiene rubber (SBR), or a polyvinylidene fluoride binder, or a combination thereof.

In still further aspects, the disclosed herein batteries can be primary or secondary. Yet, in still further aspects, the disclosed herein batteries can be secondary batteries.

It is understood that in some aspects, due to the formation of the amorphous-rich phase in the composite material, the volume of this material can change. In such aspects, the batteries can also comprise an auxiliary element that is configured to provide an external compression on the composite material to minimize a volume change of the composite material during a battery operation.

By way of example, the disclosed batteries can be used in hand-held and/or wearable electronic devices, such as a phone, watch, or laptop computer; in stationary electronic devices, such as a desktop or mainframe computer; in an electric tool, such as a power drill; in an electric or hybrid land, water, or air-based vehicles, such as a boat, submarine, bus, train, truck, car, motorcycle, moped, powered bicycle, airplane, drone, other flying vehicle, or toy versions thereof; for other toys; for energy storage, such as in storing electric power from wind, solar, wave, hydropower, or nuclear energy and/or in grid storage, or as a stationary power store for small-scale use, such as for a home, business, or hospital.

In addition, batteries, according to the present disclosure, may be multi-cell batteries containing at least about 10, at least about 100, at least about 500, between 10 and 10,000, between 100 and 10,000, between 1,000 and 10,000, between 10 and 1000, between 100 and 1,000, or between 500 and 1,000 electrochemical cells of the present disclosure. Cells in multi-cell batteries may be arranged in parallel or in series.

Also disclosed herein thin films comprising any of the disclosed above composite materials.

It is further understood that the thin film can have a thickness similar to the thickness of the composite material, as disclosed above. While in other aspects, the thickness can be greater. For example, the thickness of the thin film can be greater than disclosed above 500 nm; it can also be greater than about 600 nm, or greater than about 700 nm, or greater than about 800 nm, or greater than about 900 nm, or greater than about 1 μm. It is understood that if needed, this film can be formed on a micrometer scale.

In still further aspects, and as disclosed above, the thin film can be stable under ambient conditions. In some aspects, the films can have any of the disclosed above volumetric strains or compressions.

In still further aspects, also disclosed herein is a solid ion-conducting composite comprising: a) a thin film solid electrolyte comprising one or more of sulfide compounds, garnet structure oxides, LISICON-type solids, NASICON-type phosphate glass ceramics, perovskite-type and anti-perovskite type compounds, nitrides, oxynitrides, argyrodite-type, polymer-based electrolytes, or any combination thereof, and b) a protective layer comprising the thin film as disclosed herein and disposed on the thin film solid electrolyte surface.

It is understood that such a solid ion-conducting composite can be used in any of the disclosed herein batteries. For example, this solid ion-conducting composite can be used as an electrolyte that is in contact with the disclosed above electrode material. In such exemplary and unlimiting aspects, the protective layer formed on the solid electrolyte and the composite material is the same or different. It is understood that in some aspects, the composition of the protective layer and the composite material can be the same or different. In yet other aspects, the thickness or percentage of the amorphous phase can be the same or different. In yet other aspects, the percentage of strain stress or compression of the protective layer and the composite material can be the same or different.

In still further aspects, the solid ion-conducting composite disclosed herein can be used with electrode materials that do not comprise the composite material disclosed above. In certain aspects, the solid ion-conducting composite can be used with an anode metal material such that the protective layer of the solid ion-conducting composite is in contact with the anode. In such exemplary and unlimiting aspects, the anode metal material can be a metal whose electrochemically active surface can comprise any passivating or other functional and non-functional films disposed on its electrochemically active surface, or it can be an untreated virgin surface, or it can be polished to ensure that the electrochemically active surface comprises a pure metal.

In still further aspects, the protective layer of the solid ion-conducting composite disclosed herein is configured to substantially wet an electrochemically active surface of any of the above-disclosed anode metal materials if present. In still further aspects, the protective layer is configured to substantially prevent the formation of dendrites on the electrochemically active surface of the anode metal material under any operating conditions. In still further aspects, the protective layer is configured to substantially suppress the decomposition of the thin film solid electrolyte when it is under operating conditions.

Further disclosed herein are methods of making any of the disclosed herein electrode materials comprising ex-situ depositing or in-situ forming the substantially inorganic solid electrolyte interface material on the electrochemically active surface of the anode metal material. In such aspects, the step of depositing comprises ex-situ formation of the composite material or in-situ formation of the composite material by a chemical reaction with an ex-situ or in-situ deposited precursor layer, chemical combination of additives and/or salts added to the electrolyte, or any combination thereof.

In still other aspects, wherein the in-situ formation occurs when a carbonaceous polymeric material halogenated with a first halogen and comprises: at least one atom selected from nitrogen, oxygen, phosphorous, sulfur, boron, a second halogen that is different from the first halogen, or any combination thereof within a polymeric chain is disposed on the electrochemically active surface of the anode metal material that is in contact with an electrolyte, and a first amorphous halide salt having a cation comprising of one or more metals, wherein the one or more metals comprises the anode metal material and wherein the first amorphous halide salt is a reaction product of a reaction between the anode metal material and the electrolyte, and wherein the first amorphous halide salt is incorporated in a matrix of the carbonaceous polymeric material. While in other aspects, the in-situ formation occurs when an inorganic material halogenated with a third halogen and comprises: one or more elements of Group III and/or Group V, a fourth halogen, or a combination thereof, wherein the fourth halogen is different from the third halogen is disposed on the electrochemically active surface of the anode metal material that is in contact with an electrolyte and a second amorphous halide salt having a cation comprising of one or more metals, wherein the one or more metal comprise the anode metal material, wherein the second amorphous halide salt is a reaction product of a reaction between the anode metal material and the electrolyte, and wherein the second amorphous halide salt is incorporated in a matrix of the inorganic material.

Other methods disclosed herein also include a method of making the disclosed herein solid ion-conducting composites. Such methods can comprise depositing of any one of the disclosed herein protective layers on a surface of the thin film solid electrolyte. Again, any known in the art deposition methods suitable for the desired application can be used. In some exemplary and unlimiting aspects, the step of depositing can comprise a plasma deposition, an atomic layer deposition, a molecular layer deposition, a chemical vapor deposition, a gas-phase deposition, a solution deposition, an electrochemical deposition, or any combination thereof.

In yet still further aspects, also disclosed herein are methods of forming a battery, where these methods comprise a) providing any of the disclosed herein electrode materials; b) providing any of the disclosed herein or known in the art and suitable for the desired application electrolytes; and c) providing any of the disclosed herein or known in the art and suitable for the desired application cathode materials.

By way of a non-limiting illustration, examples of certain aspects of the present disclosure are given below.

### EXAMPLES

The following examples are put forth so as to provide those of ordinary skill in the art with a complete disclosure and description of how the compounds, compositions, articles, devices, and/or methods claimed herein are made and evaluated and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is degrees C or is at ambient temperature, and pressure is at or near atmospheric.

### Example

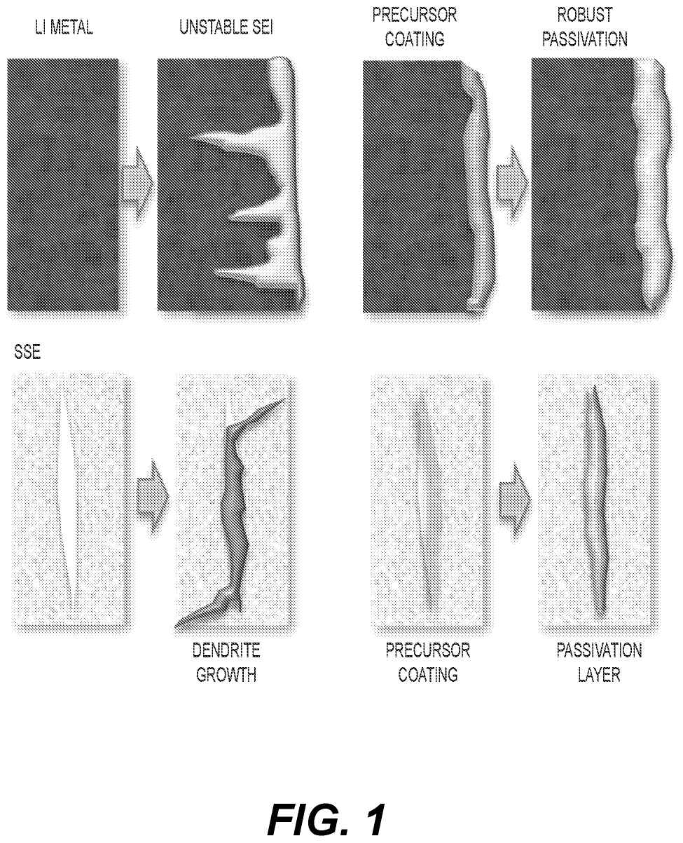

In LIBs, the precursor material layering should be designed such that it interacts significantly with lithium at key interfaces which are prone to electrolytic decomposition and dendrite growth, like the electrode/electrolyte interface, grain boundaries, extended cracks, etc. This is explained through the schematic in FIG. 1, showing the application of the precursor coating, which can react with lithium immediately to form amorphous (a)-LiF-rich protective material on the interfaces of the interest. Precursor materials undergo favorable and facile reactions with lithium both kinetically and thermodynamically, leading to amorphous LiF formation upon contact with a Li source.

### Example 1

Novel methods for in-situ formation of amorphous LiF and LiF-rich amorphous organic/inorganic composites from precursor materials through the thermodynamically favorable lithiation reaction of the precursor materials were discovered. Exemplary organic precursors studied in this disclosure include polymers like functionalized carbonaceous polymeric materials (for example, nitrogen-functionalized trifluoro-ethyl phosphate), oxygen-containing fluorocarbons (for instance, perfluoro-2-methyl-3-pentanone), halogen-containing fluorocarbons (for instance, perfluorocarbon iodide), and the like.

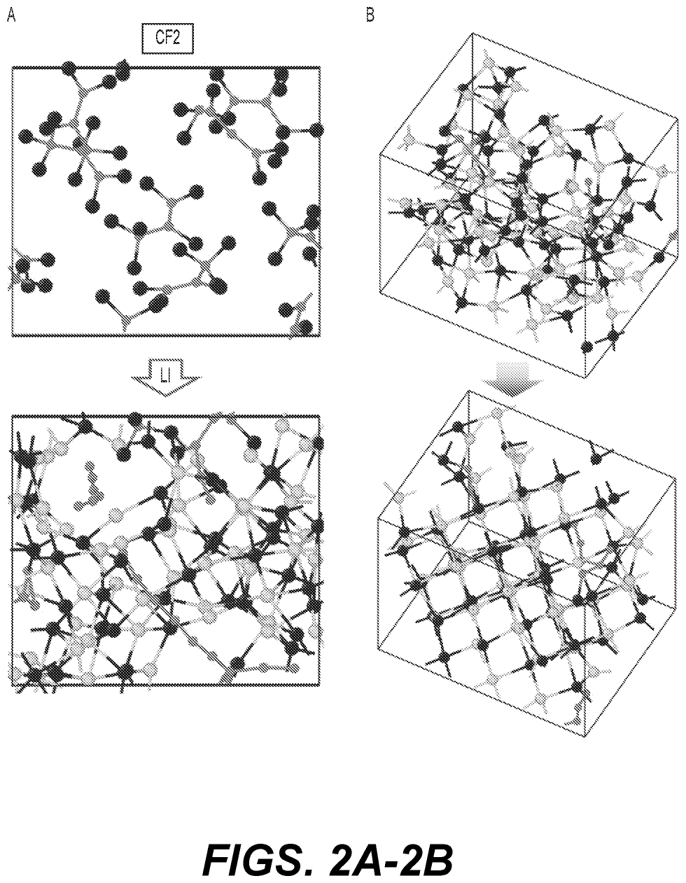

Studies to understand these lithiation reactions case by case were conducted. As a basis to design the precursor composition, the use of the fluorinated carbon structure (FC) with different C:F ratios (2,1) was suggested. Upon subsequent lithiation, LiF is formed readily, which segregates and undergoes brittle to ductile transformation (FIGS. 2A-2B). Without wishing to be bound by any theory, such structural phase transition was hypothesized to be triggered by the low reactivity between Li and C, which tend to segregate as carbonaceous chains.

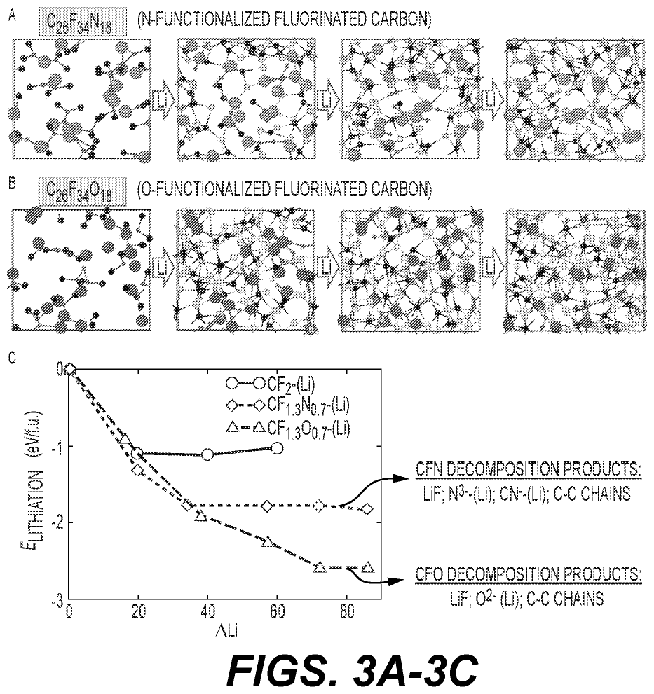

Subsequently, the composition of the fluorinated carbon structures was modified by oxygen and nitrogen functionalization. Amorphous LiF with stable lithium suboxide clusters embedded in its matrix is formed from an oxygen-functionalized fluorinated carbon, the process being illustrated in FIGS. 3A-3B using successive simulation snapshots. In the case of N-functionalized fluorinated carbon (NFC), Li-coordinated CN⁻ clusters are formed within the a-LiF-rich matrix, beyond which further decomposition does not occur (FIG. 3A, top panel). Thus, the lithiation product obtained from O⁻ functionalized fluorinated carbon (OFC) has a-LiF in-situ stabilized by O, which forms stable lithium suboxide clusters dispersed throughout the system (FIG. 3A, bottom panel). A stable OFC, like perfluoro 2-methyl 3-pentanone, was identified as a candidate precursor composition. It was also noted that NFCs type precursors can be used for the same purpose.

The lithiation capacities of exemplary and unlimiting precursors such as NFC, OFC, and FC were examined through the formation of energy profiles over lithium incorporation (FIG. 3C). It was found that OFC demonstrates much higher lithiation capacity, thanks to the decomposition of OFC into heavily Li-coordinated lithium suboxides over successive Li-addition: a reaction which is evidently energetically favorable. NFCs and FC, on the other hand, show lower lithiation capacity, as there is no further reactivity and lithiation-induced decomposition after Li—CN⁻ clusters, as well as segregated carbon chains, are formed.

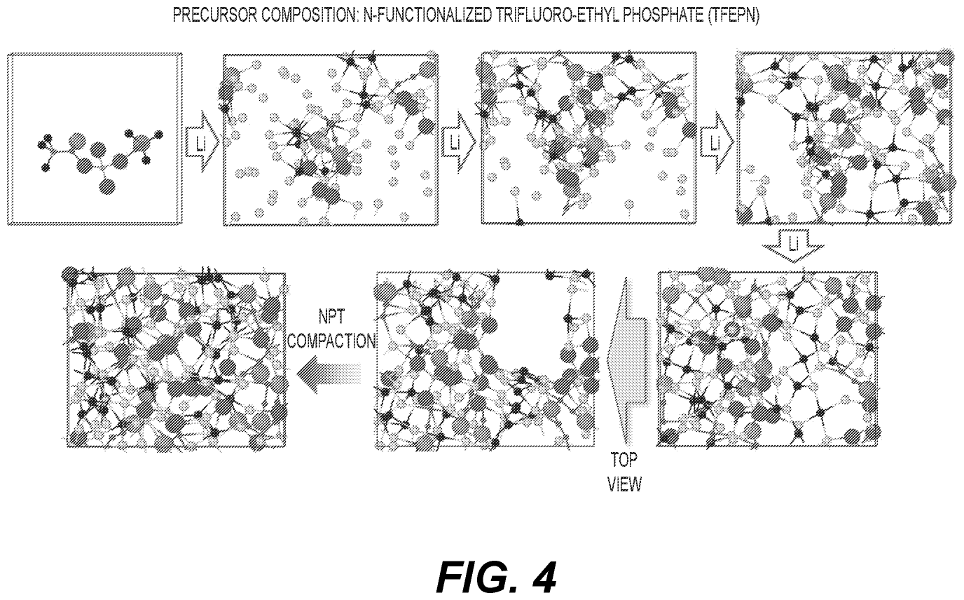

It was found that the application of probable and similar precursor compositions can be extended to halogen-containing fluorocarbons (for instance, perfluorocarbon iodide). Furthermore, dabbling with heteroatom-functionalized carbonaceous polymeric materials, a nitrogen-functionalized difluoro-ethyl phosphate (denoted as TFEPN) was identified as a candidate composition, which shows immediate reactivity with lithium as fluorine from TFEPN chains is consumed by Li to form a-LiF rich lithiation product (FIG. 4). Lithiation-induced decomposition of TFEPN chains leads to stable C—C—N fragments and phosphate (PO₄) polyanions being dispersed throughout the matrix, which interacts strongly with surrounding Li and helps stabilize the amorphous LiF network.

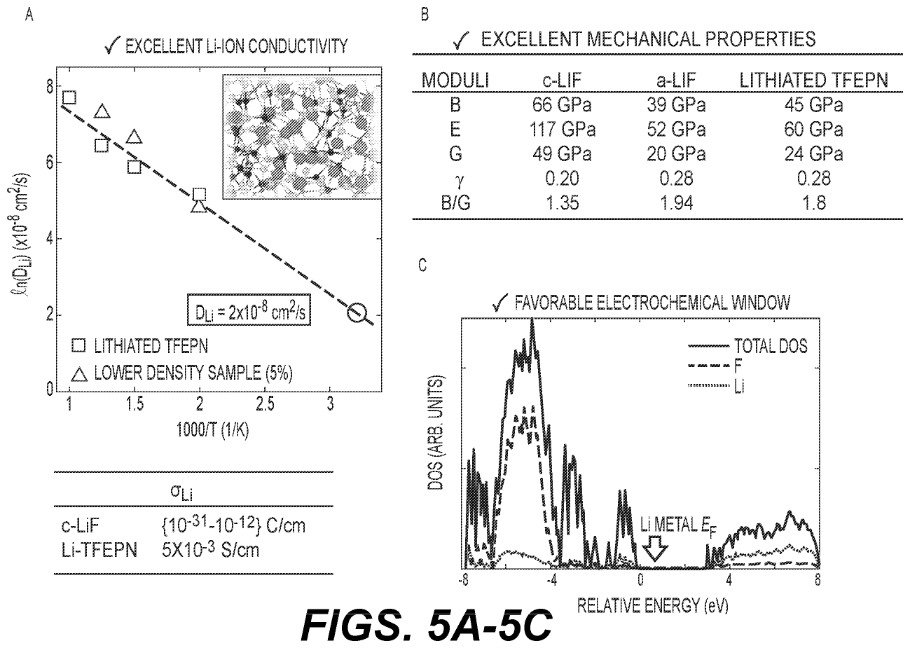

Furthermore, the room-temperature diffusivity of Li was examined using AIMD simulations. The mean-square displacements (MSD) of Li atoms were calculated with varying temperatures; MSD=|Rᵢ(t)−Rᵢ(0)|², where Rᵢ(t) is the position of atom i at time t. Based on the MSD profiles, the self-diffusion coefficients for Li were computed using the Einstein relation, D_{Li}=<MSD>/6t, where the angular bracket denotes the ensemble average over the AIMD interval. The logarithm of D_{Li} values tends to follow a linear trend with respect to the reciprocal of temperature, and an Arrhenius functional form is subsequently fitted to the plot of D_{Li} against the inverse of temperature. As can be seen from the fit, the Li self-diffusion coefficient at 300K in the disclosed herein a-LiF composite is estimated to be approximately 2×10⁻⁸ cm²/sec (FIG. 5A), which is many orders of magnitude higher than that predicted for D_{Li} in c-LiF. Making use of the diffusivity and the Nernst-Einstein relation, ionic conductivity can be approximated by

$$σ = \frac{{ne}^{2} {z}^{2}}{{k}_{B} T} {D}_{Li} ,$$

where n is the diffusing particle (Li) density, e is the elementary charge, kB is the Boltzmann constant, and T is the temperature in Kelvin.

The Li-ion conductivity of the amorphous LiF-rich composites formed in situ was found to be very high. It is predicted to be ˜5 mS/cm at room temperature (FIG. 5A), which is comparable to that in conventional liquid electrolytes (˜1-10 mS/cm) and several orders of magnitude higher than that in c-LiF.

To gain insight into the electronic properties of typical in-situ synthesized a-LiF-rich composites, the calculated electronic density of states of the LiF-rich lithiation product formed from TFEPN is plotted in FIG. 5B; here, the Li 1s core level is set to zero as a reference. It should be noted that DFT-GGA calculations significantly underestimate the band gap. In spite of the band gap narrowing compared to crystalline LiF (c-LiF), the disclosed herein a-LiF-rich composite is still seen to provide a reasonable gap and retains its unique electron blocking ability, and the Li-metal fermi level (dotted line) lies within the band gap.

It is also important to investigate the mechanical properties of the in-situ lithiation-induced a-LiF-rich composite. In order to probe the effect of LiF structure on the elastic properties, the estimated bulk modulus (B), shear modulus (G), elastic modulus (E), and Poisson's ration (y), as well as the Pugh's ratio (B/G) were calculated, as tabulated in FIG. 5C. Similar to pristine a-LiF, the bulk modulus of the disclosed herein a-LiF -rich composite is found to be lower than that of crystalline (c)-LiF, which is in sync with the behavior of the amorphous phase of a material. Similar trends can be observed from the shear modulus and elastic modulus. Pugh's ration and Poisson's ratio are considered indicators to predict the failure mode, i.e., the brittle or ductile nature of materials. The critical B/G value for material transformation from brittle to ductile is generally considered to be about 1.75. Additionally, the Frantsevich rule points towards a y value of 0.26 as the separation between brittle and ductile materials. The calculated elastic moduli, as well as the B/G and y values, strongly indicate distinctly ductile character and significantly enhanced fracture resistance of amorphous-LiF-rich composite compared to crystalline-LiF.

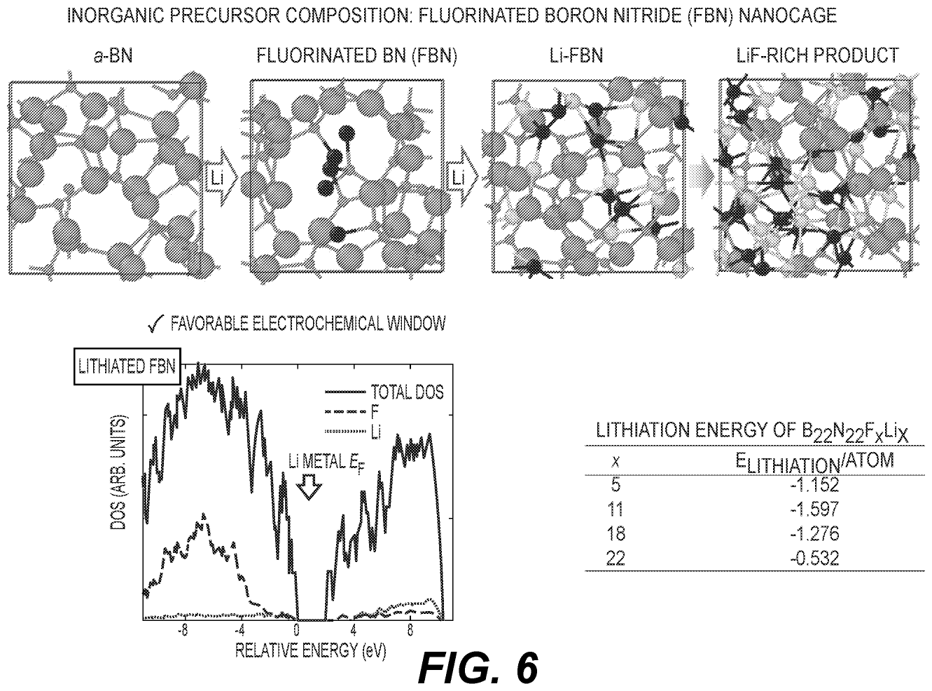

As another example, it was shown in FIG. 6 how the application of probable and similar precursor compositions can be extended to a fluorinated boron nitride nanocage, the lithiation of which can yield amorphous LiF fillings.

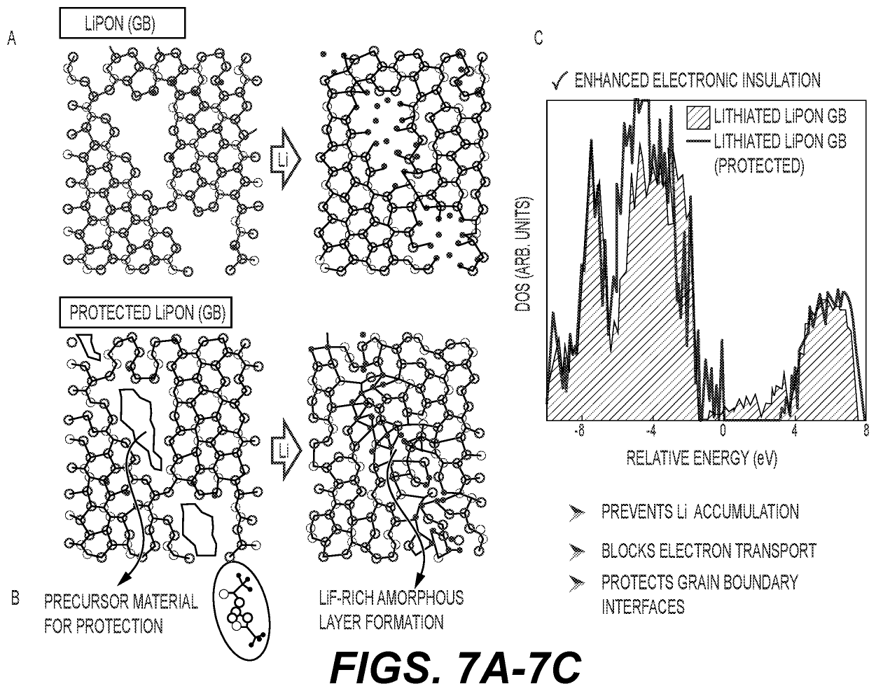

FIGS. 7A-7C show the effect of an exemplary TFEPN precursor applied at a LiPON gran boundary (GB).

### Example 2

Furthermore, the search for suitable precursors is also extended to inorganic domains to facilitate the convenient formation of nanocages and thin films made of Group III and Group V elements, like halogen-functionalized boron nitride (for instance, fluorinated amorphous boron nitride), halogen-functionalized boron phosphide, and the like. For instance, the results, as demonstrated in FIG. 6, indicate the formation of the a-LiF matrix within the boron nitride cage upon defluorination, with negative lithiation energies pointing towards its high reactivity with lithium. The electronic density of states of the lithiation product again reflects the substantial capacity for electronic insulation.

In summary, upon lithiation that causes defluorination of the precursor material, stable components are identified which remain well dispersed in the amorphous LiF-rich composite, like C—C—N fragments, phosphate polyanions, monoatomic/polyatomic anions, porous inorganic matrices, depending on the choice of precursor material. The types of decomposition components are primarily responsible for the stabilization of amorphous LiF. Lithiation of the right precursor materials lends desirable control to the composition of the resulting hetero-species-embedded amorphous LiF formed in situ.

The combination of excellent ion transport properties, electron blocking ability, and desirable mechanical properties of the in-situ LiF-rich composites formed makes the family of precursor materials excellent candidates for practical use as an interfacial coating layer that can effectively suppress electrolyte decomposition and Li dendrite propagation while simultaneously improving the contact and compatibility of the electrode/electrolyte interface.

### ASPECTS

In view of the described electrode materials, batteries, and methods and variations thereof, herein below are described certain more particularly described aspects of the inventions. The particularly recited aspects should not, however, be interpreted to have any limiting effect on any different claims containing different or more general teachings described herein or that the “particular” aspects are somehow limited in some way other than the inherent meanings of the language and formulas literally used therein.

Aspect 1: An electrode material comprising: an anode metal material having an electrochemically active surface; a composite material comprising: a) a carbonaceous polymeric material halogenated with a first halogen and comprising: at least one atom selected from nitrogen, oxygen, phosphorous, sulfur, boron, a second halogen that is different from the first halogen, or any combination thereof within a polymeric chain; and a first amorphous halide salt incorporated in a matrix of the carbonaceous polymeric material, wherein the first amorphous halide salt comprises a cation of one or more metals, wherein the one or more metals comprise the anode metal material and wherein an anion of the first amorphous halide salt comprises the first halogen or the second halogen, or a mixture thereof; or b) an inorganic material halogenated with a third halogen and comprising: one or more elements of Group III and/or Group V, a fourth halogen, or a combination thereof, wherein the fourth halogen is different from the third halogen; and a second amorphous halide salt incorporated in a matrix of the inorganic material, wherein the second amorphous halide salt comprises a cation of one or more metals, wherein the one or more metals comprise the anode metal material; and wherein an anion of the second amorphous halide salt comprises the third halogen, the fourth halogen, or a mixture thereof; and wherein the composite material is a layer disposed on the electrochemically active surface of the anode metal material.

Aspect 2: The electrode material of Aspect, wherein the anode metal material comprises lithium, sodium, potassium, magnesium, aluminum, zinc, or alloys thereof.

Aspect 3: The electrode material of any one of Aspects 1-2, wherein when the composite material comprises the carbonaceous polymeric material halogenated with the first halogen, the first halogen and/or second halogen, if present, comprises an F, Cl, Br, and/or I.

Aspect 4: The electrode material of Aspect 3, wherein the first halogen is F.

Aspect 5: The electrode material of any one of Aspects 3-4, wherein the second halogen, if present, is I.

Aspect 6: The electrode material of any one of Aspects 3-5, wherein, within the carbonaceous polymeric material a ratio of the first halogen to carbon is between 0 and 2.

Aspect 7: The electrode material of any one of Aspects 3-6, wherein the carbonaceous polymeric material halogenated with the first halogen comprises one or more of nitrogen functionalized trifluoro-ethyl phosphate, nitrogen functionalized difluoro-ethyl phosphate, perfluoro-2-methyl-3-pentanone, perfluorocarbon iodide, or any combination thereof.

Aspect 8: The electrode material of any one of Aspects 1-7, wherein when the composite material comprises the inorganic material halogenated with the third halogen, the third halogen and/or fourth halogen, if present, comprises an F, Cl, Br, and/or I.

Aspect 9: The electrode material of Aspect 8, wherein the third halogen is F.

Aspect 10: The electrode material of any one of Aspects 8-9, wherein the inorganic material halogenated with the third halogen comprises fluorinated boron nitride, fluorinated boron phosphide, or any combination thereof.

Aspect 11: The electrode material of any one of Aspects 1-10, wherein the one or more metals further comprise an alkali or an alkaline-earth metal material that is different from the anode metal material.

Aspect 12: The electrode material of any one of Aspects 1-11, wherein the anode metal material is lithium.

Aspect 13: The electrode material of any one of Aspects 1-12, wherein the first and/or the second halide salt is amorphous lithium fluoride.

Aspect 14: The electrode material of any one of Aspects 1-13, wherein the composite material is present as a continuous thin film.

Aspect 15: The electrode material of any one of Aspects 1-14, wherein the composite material exhibits an ion conductivity ranging from about 1 mS/cm to about 20 mS/cm at room temperature.

Aspect 16: The electrode material of Aspect 15, wherein the ion conductivity of the composite material is about 10 mS/cm at room temperature.

Aspect 17: The electrode material of any one of Aspects 1-16, wherein a metal anode material cation self-diffusion coefficient in the composite material is from about 5×10⁻¹⁰ to about 10⁻⁷ cm²/s.

Aspect 18: The electrode material of any one of Aspects 1-17, wherein the composite material is a substantially electrical insulator.

Aspect 19: The electrode material of Aspect 18, wherein the composite material exhibits electrical resistivity greater than about 10⁷ Ω·cm.

Aspect 20: The electrode material of any one of Aspects 1-19, wherein the composite material exhibits a bulk modulus from about 35 GPa to about 60 GPa.

Aspect 21: The electrode material of any one of Aspects 1-20, wherein the composite material exhibits a shear modulus from about 15 GPa to about 30 GPa.

Aspect 22: The electrode material of any one of Aspects 1-21, wherein the composite material exhibits an elastic modulus from about 45 GPa to about 70 GPa.

Aspect 23: The electrode material of any one of Aspects 1-22, wherein the composite material is ductile.

Aspect 24: The electrode material of any one of Aspects 1-23, wherein the electrochemically active surface comprises an anode metal material/electrolyte interface, one or more grain boundaries in the anode metal material, one or more cracks in the anode metal material, or any combination thereof.

Aspect 25: The electrode material of any one of Aspects 1-24, wherein the composite material is a solid electrolyte interface (SEI) layer.

Aspect 26: The electrode material of any one of Aspects 1-25, wherein the composite material is configured to substantially wet the electrochemically active surface of the anode metal material.

Aspect 27: The electrode material of any one of Aspects 1-26, wherein the composite material has a volumetric strain greater than 0% and less than 100%.

Aspect 28: The electrode material of any one of Aspects 1-26, wherein the composite material has a volumetric compression.

Aspect 29: The electrode material of any one of Aspects 1-28, wherein the composite material is configured to substantially prevent formation of dendrites on the electrochemically active surface of the anode metal material.

Aspect 30: The electrode material of any one of Aspects 1-29, wherein the composite material is configured to substantially suppress decomposition of an electrolyte when it is in contact with the electrolyte.

Aspect 31: A battery comprising the electrode material of any one of Aspects 1-30.

Aspect 32: The battery of Aspect 31, further comprising an electrolyte.

Aspect 33: The battery of Aspect 32, wherein the electrolyte is a liquid.

Aspect 34: The battery of Aspect 33, wherein the electrolyte is a solid.

Aspect 35: The battery of Aspect 34, wherein the composite material is configured to substantially wet a surface of the solid electrolyte that is in contact with the anode metal material.

Aspect 36: The battery of Aspect 33, wherein the electrolyte comprises a salt of a metal cation and a non-aqueous organic solvent.

Aspect 37: The battery of Aspect 36, wherein the metal cation comprises lithium, sodium, potassium, magnesium, aluminum, zinc, or a combination thereof.

Aspect 38: The battery of Aspects 36 or 37, wherein the non-aqueous (organic) solvent comprises an ethylene carbonate, dimethyl carbonate, diethyl carbonate, propylene carbonate, dimethoxyethane, ethyl methyl carbonate, N-methyl acetamide, acetonitrile, symmetric sulfone, sulfolane, polyethylene glycol, 1,3-dioxolane, glymes, siloxane, ethylene oxide grafted sulfolane, or a combination thereof.

Aspect 39: The battery of Aspect 34 or 35, wherein the electrolyte is solid and comprises sulfide compounds, garnet structure oxides, LISICON-type solids, NASICON-type phosphate glass ceramics, perovskite-type and anti-perovskite type compounds, nitrides, oxynitrides, argyrodite-type, or polymer-based electrolytes, or any combination thereof.

Aspect 40: The battery of Aspect 39, wherein the electrolyte comprises a lithium germanium phosphorous sulfide electrolyte, a lithium phosphorus oxynitride electrolyte, a lithium phosphorous sulfide electrolyte, lithium lanthanum zirconium oxide, lithium lanthanum titanium oxide, lithium aluminum germanium phosphate, lithium nitride, or any combination thereof.

Aspect 41: The battery of any one of Aspects 31-40, further comprising a cathode material.

Aspect 42: The battery of Aspect 41, wherein the cathode material is a metal cathode or a composite cathode.

Aspect 43: The battery of Aspect 42, wherein the cathode comprises copper, carbon, graphite, sodium, potassium, lithium, magnesium, calcium, aluminum, layered oxides, vanadium-based cathode, sulfur-based cathode, manganese-based cathode, rocksalt cathode, disordered rocksalt cathode, lithium-rich cathode, high voltage ceramic, low voltage ceramic, NMC (nickel-manganese-cobalt oxide) cathode, NCA (nickel-cobalt-aluminum oxide) cathode, LCO (lithium-cobalt oxide) cathode, LFP (lithium iron phosphate) cathode, fluoride-based cathode, sulfur selenium cathode, sulfur selenium tellurium cathode, spinels, olivines, or any combination thereof.

Aspect 44: The battery of Aspect 43, wherein the cathode comprises a composite material comprising λ-MnO₂, LiMn₂O₄ spinel, olivine LiFePO₄, FePO₄, layered LiCoO₂ (LCO), LiNi_{y}Mn_{y}Co_{1-2y}O₂ (NMC), LiNiMnO₂, or any combination thereof.

Aspect 45: The battery of any one of Aspects 41-44, wherein the cathode comprises a LiFePO₄ composite cathode, a LINi_{0.8}Co_{0.15}Al_{0.05}O₂, a LiNi_{1/3}Mn_{1/3}Co_{1/3}O₂, a LiNi_{0.4}Mn_{0.3}Co_{0.3}O₂, a LiNi_{0.5}Mn_{0.3}Co_{0.2}O₂, a LiNi_{0.6}Mn_{0.2}Co_{0.2}O₂, a LiNi_{0.8}Mn_{0.1}Co_{0.1}O₂ composite cathode.

Aspect 46: The battery of any one of Aspects 41-45, wherein the cathode comprises a poly(ethylene oxide), cellulose, carboxymethylcellulose (CMC), polytetrafluoroethylene (PTFE), styrene-butadiene rubber (SBR), a polyvinylidene fluoride binder; or any combination thereof.

Aspect 47: The battery of any one of Aspects 31-46, wherein the battery is a secondary battery.

Aspect 48: The battery of any one of claims 31-47, further comprising an auxiliary element configured to provide an external compression on the composite material to minimize a volume change of the composite material during a battery operation.

Aspect 49: A thin film comprising a composite material comprising: a carbonaceous polymeric material halogenated with a first halogen and comprising: at least one atom selected from nitrogen, oxygen, phosphorous, sulfur, boron, a second halogen that is different from the first halogen, or any combination thereof within a polymeric chain; and a first amorphous halide salt incorporated in a matrix of the carbonaceous polymeric material, wherein the first amorphous halide salt comprises a metal cation and an anion of the first and/or second halogen.

Aspect 50: A thin film comprising a composite material comprising: an inorganic material halogenated with a third halogen and comprising: one or more elements of Group III and/or Group V, a fourth halogen, or a combination thereof, wherein the fourth halogen is different from the third halogen; and a second amorphous halide salt incorporated in a matrix of the inorganic material, wherein the second halide salt comprises a metal cation and an anion of the third and/or fourth halogen.

Aspect 51: The thin film of Aspect 49 or 50, wherein the metal cation comprises lithium, sodium, potassium, magnesium, aluminum, zinc, or a combination thereof.

Aspect 52: The thin film of any one of Aspects 49-51, wherein the first and/or the second halide salt comprises Cl, F, I, Br, or a combination thereof.

Aspect 53: The thin film of any one of Aspects 49-52, wherein the ion conductivity of the thin film is about 10 mS/cm at room temperature.

Aspect 54: The thin film of any one of Aspects 49-53, wherein the thin film is a substantially electrical insulator.

Aspect 55: The thin film of Aspect 54, wherein the thin film exhibits electrical resistivity greater than about 10⁷ Ω·cm.

Aspect 56: The thin film of any one of Aspects 49-55, wherein the thin film exhibits a bulk modulus from about 35 GPa to about 60 GPa.

Aspect 57: The thin film of any one of Aspects 49-56, wherein the thin film exhibits a shear modulus from about 15 GPa to about 30 GPa.

Aspect 58: The thin film of any one of Aspects 49-57, wherein the thin film exhibits an elastic modulus from about 45 GPa to about 70 GPa.

Aspect 59: The thin film of any one of Aspects 49-58, wherein the thin film is ductile.

Aspect 60: The thin film of any one of Aspects 49-59, wherein the composite material has a volumetric strain greater than 0% and less than 100%.

Aspect 61: The thin film of any one of Aspects 49-59, wherein the composite material exhibits a volumetric compression.

Aspect 62: A solid ion-conducting composite comprising: a) a thin film solid electrolyte comprising one or more of sulfide compounds, garnet structure oxides, LISICON-type solids, NASICON-type phosphate glass ceramics, perovskite-type and anti-perovskite type compounds, nitrides, oxynitrides, argyrodite-type, polymer-based electrolytes, or any combination thereof, and b) a protective layer comprising the thin film of any one of Aspects 49-61 disposed on the thin film solid electrolyte surface.

Aspect 63: The solid ion-conducting composite of Aspect 62, wherein the protective layer is configured to substantially wet an electrochemically active surface of an anode metal material if present.

Aspect 64: The solid ion-conducting composite of Aspect 63, wherein the protective layer is configured to substantially prevent formation of dendrites on the electrochemically active surface of the anode metal material.

Aspect 65: The solid ion-conducting composite of any one of Aspects 62-64, wherein the protective layer is configured to substantially suppress decomposition of the thin film solid electrolyte.

Aspect 66: A method of making the electrode material of any one of Aspects 1-30 comprising depositing or in-situ forming the composite material on the electrochemically active surface of the anode metal material.

Aspect 67: The method of Aspect 66, wherein the step of depositing comprises ex-situ formation of the composite material or in-situ formation of the composite material by a chemical reaction with an ex-situ or in-situ deposited precursor layer, chemical combination of additives and/or salts added to an electrolyte, or any combination thereof.

Aspect 68: The method of Aspect 66, wherein the in-situ formation occurs when a carbonaceous polymeric material halogenated with a first halogen and comprises: at least one atom selected from nitrogen, oxygen, phosphorous, sulfur, boron, a second halogen that is different from the first halogen, or any combination thereof within a polymeric chain is disposed on the electrochemically active surface of the anode metal material that is in contact with an electrolyte, and a first amorphous halide salt having a cation comprising of one or more metals, wherein the one or more metals comprises the anode metal material and wherein the first amorphous halide salt is a reaction product of a reaction between the anode metal material and the electrolyte, and wherein the first amorphous halide salt is incorporated in a matrix of the carbonaceous polymeric material.

Aspect 69: The method of Aspect 66, wherein the in-situ formation occurs when an inorganic material halogenated with a third halogen and comprises: one or more elements of Group III and/or Group V, a fourth halogen, or a combination thereof, wherein the fourth halogen is different from the third halogen is disposed on the electrochemically active surface of the anode metal material that is in contact with an electrolyte and a second amorphous halide salt having a cation comprising of one or more metals, wherein the one or more metal comprise the anode metal material, wherein the second amorphous halide salt is a reaction product of a reaction between the anode metal material and the electrolyte, and wherein the second amorphous halide salt is incorporated in a matrix of the inorganic material.

Aspect 70: A method of forming a battery of any one of Aspects 31-49, comprising: a) providing the electrode material of any one of Aspects 1-30; b) providing an electrolyte; and c) providing a cathode material.

1. An electrode material comprising:
an anode metal material comprising lithium, sodium, potassium, magnesium, aluminum, zinc, or alloys thereof and having an electrochemically active surface; and
a composite material comprising:
a) a carbonaceous polymeric material halogenated with a first halogen and comprising:
at least one atom selected from nitrogen, oxygen, phosphorous, sulfur, boron, a second halogen that is different from the first halogen, or any combination thereof within a polymeric chain; and
a first amorphous halide salt incorporated in a matrix of the carbonaceous polymeric material, wherein the first amorphous halide salt comprises a cation of one or more metals, wherein the one or more metals comprise the anode metal material and wherein an anion of the first amorphous halide salt comprises the first halogen or the second halogen, or a mixture thereof; or
b) an inorganic material halogenated with a third halogen and comprising:
one or more elements of Group III and/or Group V, a fourth halogen, or a combination thereof, wherein the fourth halogen is different from the third halogen; and
a second amorphous halide salt incorporated in a matrix of the inorganic material, wherein the second amorphous halide salt comprises a cation of one or more metals, wherein the one or more metals comprise the anode metal material; and
wherein an anion of the second amorphous halide salt comprises the third halogen, the fourth halogen, or a mixture thereof, and
wherein the composite material is a layer disposed on the electrochemically active surface of the anode metal material.

2. (canceled)

3. The electrode material of claim 1, wherein when the composite material comprises the carbonaceous polymeric material halogenated with the first halogen, the first halogen and/or second halogen, if present, comprises an F, Cl, Br, and/or I and/or
wherein the carbonaceous polymeric material halogenated with the first halogen comprises one or more of nitrogen-functionalized trifluoro-ethyl phosphate, nitrogen-functionalized difluoro-ethyl phosphate, perfluoro-2-methyl-3-pentanone, perfluorocarbon iodide, or any combination thereof.

4. The electrode material of claim 3, wherein the first halogen is F, and wherein the second halogen, if present, is I.

5. (canceled)

6. The electrode material of claim 3, wherein within the carbonaceous polymeric material a ratio of the first halogen to carbon is between 0 and 2.

7. (canceled)

8. The electrode material of claim 1, wherein when the composite material comprises the inorganic material halogenated with the third halogen, the third halogen and/or fourth halogen, if present, comprises an F, Cl, Br, and/or I.

9. (canceled)

10. The electrode material of claim 8, wherein the inorganic material halogenated with the third halogen comprises fluorinated boron nitride, fluorinated boron phosphide, or any combination thereof.

11. (canceled)

12. The electrode material of claim 1, wherein the anode metal material is lithium and wherein the first and/or the second halide salt is amorphous lithium fluoride.

13. (canceled)

14. (canceled)

15. The electrode material of claim 1, wherein the composite material exhibits an ion conductivity ranging from about 1 mS/cm to about 20 mS/cm at room temperature and/or wherein the composite material exhibits electrical resistivity greater than about 10⁷ Ω·cm, and/or wherein a metal anode material cation self-diffusion coefficient in the composite material is from about 5×10⁻¹⁰ to about 10⁻⁷ cm²/s.

16.-24. (canceled)

25. The electrode material of claim 1, wherein the composite material is a solid electrolyte interface (SEI) layer and wherein the composite material is configured to substantially prevent formation of dendrites on the electrochemically active surface of the anode metal material.

26. (canceled)

27. The electrode material of claim 1, wherein the composite material has a volumetric strain greater than 0% and less than 100% and wherein the composite material exhibits a volumetric compression.

28. (canceled)

29. (canceled)

30. (canceled)

31. A battery comprising the electrode material of claim 1, an electrolyte and a cathode.

32.-35. (canceled)

36. The battery of claim 31, wherein when the electrolyte is a liquid, the liquid electrolyte comprises a salt of a metal cation and a non-aqueous organic solvent or wherein when the electrolyte is a solid, the solid electrolyte comprises sulfide compounds, garnet structure oxides, LISICON-type solids, NASICON-type phosphate glass ceramics, perovskite-type and anti-perovskite type compounds, nitrides, oxynitrides, argyrodite-type, or polymer-based electrolytes, or any combination thereof.

37.-42. (canceled)

43. The battery of claim 31, wherein the cathode comprises copper, carbon, graphite, sodium, potassium, lithium, magnesium, calcium, aluminum, layered oxides, vanadium-based cathode, sulfur-based cathode, manganese-based cathode, rocksalt cathode, disordered rocksalt cathode, lithium-rich cathode, high voltage ceramic, low voltage ceramic, NMC (nickel-manganese-cobalt oxide) cathode, NCA (nickel-cobalt-aluminum oxide) cathode, LCO (lithium cobalt oxide) cathode, LFP (lithium iron phosphate) cathode, fluoride-based cathode, sulfur selenium cathode, sulfur selenium tellurium cathode, spinels, olivines, or any combination thereof.

44.-47. (canceled)

48. The battery of claim 1, further comprising an auxiliary element configured to provide an external compression on the composite material to minimize a volume change of the composite material during a battery operation.

49. A thin film comprising a composite material comprising:
a carbonaceous polymeric material halogenated with a first halogen and comprising: at least one atom selected from nitrogen, oxygen, phosphorous, sulfur, boron, a second halogen that is different from the first halogen, or any combination thereof within a polymeric chain; and a first amorphous halide salt incorporated in a matrix of the carbonaceous polymeric material, wherein the first amorphous halide salt comprises a metal cation and an anion of the first and/or second halogen or
an inorganic material halogenated with a third halogen and comprising: one or more elements of Group III and/or Group V, a fourth halogen, or a combination thereof, wherein the fourth halogen is different from the third halogen; and a second amorphous halide salt incorporated in a matrix of the inorganic material, wherein the second halide salt comprises a metal cation and an anion of the third and/or fourth halogen.

50.-61. (canceled)

62. A solid ion-conducting composite comprising:
a) a thin film solid electrolyte comprising one or more of sulfide compounds, garnet structure oxides, LISICON-type solids, NASICON-type phosphate glass ceramics, perovskite-type and anti-perovskite type compounds, nitrides, oxynitrides, argyrodite-type, polymer-based electrolytes, or any combination thereof, and
b) a protective layer comprising the thin film of claim 49 disposed on a thin film solid electrolyte surface.

63. (canceled)

64. (canceled)

65. (canceled)

66. A method of making the electrode material of claim 1 comprising depositing or in-situ forming the composite material on the electrochemically active surface of the anode metal material.

67. The method of claim 66, wherein the step of depositing comprises ex-situ formation of the composite material, or in-situ formation of the composite material by a chemical reaction with an ex-situ or in-situ deposited precursor layer, chemical combination of additives and/or salts added to an electrolyte, or any combination thereof.

68. The method of claim 66, wherein the in-situ formation occurs when a carbonaceous polymeric material halogenated with a first halogen and comprises: at least one atom selected from nitrogen, oxygen, phosphorous, sulfur, boron, a second halogen that is different from the first halogen, or any combination thereof within a polymeric chain is disposed on the electrochemically active surface of the anode metal material that is in contact with an electrolyte, and a first amorphous halide salt having a cation comprising of one or more metals, wherein the one or more metals comprises the anode metal material and wherein the first amorphous halide salt is a reaction product of a reaction between the anode metal material and the electrolyte, and wherein the first amorphous halide salt is incorporated in a matrix of the carbonaceous polymeric material.

69. The method of claim 66, wherein the in-situ formation occurs when an inorganic material halogenated with a third halogen and comprises: one or more elements of Group III and/or Group V, a fourth halogen, or a combination thereof, wherein the fourth halogen is different from the third halogen is disposed on the electrochemically active surface of the anode metal material that is in contact with an electrolyte and a second amorphous halide salt having a cation comprising of one or more metals, wherein the one or more metal comprise the anode metal material, wherein the second amorphous halide salt is a reaction product of a reaction between the anode metal material and the electrolyte, and wherein the second amorphous halide salt is incorporated in a matrix of the inorganic material.

70. (canceled)
